(19) United States
(12) Patent Application Publication
(10) Pub. No.: US 2004/0084226 A1
(43) Pub. Date: May 6, 2004

(54) Auto weight

(76) Inventor: Alfred Wright, Vineland, NJ (US)

Correspondence Address: Alfred Wright, 607 E. Oxford St., Vineland, NJ, 08360, US

(21) Appl. No.: 10/283,499

(22) Filed: Oct. 31, 2002

(51) Int. Cl. G01G 23/18; G01G 19/08

(52) U.S. Cl. 177/45; 177/136

(57) ABSTRACT

My invention is unique in that there is currently no device currently incorporated in automobiles, trains, planes, trucks, or vessels that automatically or manually provides occupants and/or cargo weight to the person(s) requiring such information. My invention incorporates a weighing system (digital or analog), in a transportation vehicle or vessel, that automatically or manually provides occupant(s) and/or cargo weight to the person(s) requiring such information for safety, law enforcement, personal, or any other use. For example: A manufactured Pick-up truck would offer the option of the owner(s) to automatically and/or manually, determine the weight of cargo and/or occupants, through digital and/or analog interpretation.

### SUMMARY

A device incorporated into auto's, truck's, trailers, railcars, and all other types of vehicles (motorized and non-motorized); That weighs the vehicle itself, contents, cargo, persons, or other articles.

### DETAILED DESCRIPTION

A device that will display and/or record the weight of vehicles and/or their cargo and/or occupants. A digital or analog reading, will be available to persons, desiring to know the weight of vehicles, and any additional weight such as cargo, persons, and other articles stored in said vehicle. Emergency alerts would be incorporated within the device to sound a warning when any manufacturer weight limits have been exceeded. Such device would be placed on/in/below manufactured transportation vehicles and trailers to manually or electronically transfer weight readings to an accessible area on/in the said vehicle. Synchronization mechanisms shall allow certified manufacturers and dealers, to periodically adjust weight readings to accurately record weights in accordance with all current or changing factors. This weight device (scale), will also be used in the manufacturing of sea going vessels, boats, and watercraft, utilizing special components to avoid the detrimental affects of water damage where necessary. Encompassed in this specification is all devices incorporated in to vehicles, vessels, trains, railcars, non-motorized bicycles, motorcycles, boats, Jet-ski's, trailers, tractors, aircraft; To obtain weight of the vehicle, vessel, or plane itself, or it's cargo, passengers, and articles. The overweight limit warning also has the availability of disabling the said vehicle, until proper manufacturer or government proscribed weights are adhered to.

1. What I claim as my invention is the “AUTO WEIGH” which is a device, machine, component or combination, that weigh's person(s) freight luggage, articles or combination. This device is to be a manufactured part of the Auto, Train, Truck, Vessel, aircraft, or will be an after market add-on to such vehicles, vessel's or aircraft.
